(19) United States
(12) Patent Application Publication
(10) Pub. No.: US 2013/0229712 A1
(43) Pub. Date: Sep. 5, 2013

(54) SANDWICHED DIFFRACTIVE OPTICAL COMBINER

(71) Applicant: Bernard C. Kress, Redwood City, CA (US)

(72) Inventor: Bernard C. Kress, Redwood City, CA (US)

(73) Assignee: GOOGLE INC., Mountain View, CA (US)

(21) Appl. No.: 13/411,346

(22) Filed: Mar. 2, 2012

(51) Int. Cl. G02B 27/01; B29D 11/00; G02B 5/18

(52) U.S. Cl. 359/572; 216/24

(57) ABSTRACT

An optical combiner includes a two-dimensional (“2D”) array of three-dimensional (“3D”) diffraction element shapes disposed in a first side of a base sandwich layer. Partially reflective elements coat each of the 3D diffraction element shapes. The partially reflective elements collectively form a reflective diffraction grating having magnifying optical power for image light incident on the reflective diffraction grating through an eye-ward side of the optical combiner. A planarization sandwich layer is disposed over the partially reflective elements and has an index of refraction substantially equal to that of the base sandwich layer such that external scene light incident through the external scene side passes through the optical combiner substantially without diffraction while the image light incident through the eye-ward side is reflected and magnified via the reflective diffraction grating.

### TECHNICAL FIELD

This disclosure relates generally to the field of optics, and in particular but not exclusively, relates to diffractive elements.

### BACKGROUND INFORMATION

In the field of optics, a combiner is an optical apparatus that combines two images together, from either the same side of the combiner (reflective/reflective, or transmissive/transmissive) or from the two different sides of the combiner (reflective/transmissive). Often times, optical combiners are used in heads up displays (“HUDs”), which allow a user to view a computer generated image (“CGI”) superimposed over an external view. The HUD enables the user to view the CGI without having to look away from his usual viewpoint. The term HUD originated from its use in avionics, which enabled a pilot to view information while looking forward with his head up, as opposed to looking down at an instrument panel. Conventional HUDs include tilted dichroic plates, holographic combiners, angled transparent substrates, and compound conjugate lenses.

Two version of combiners exist. The first version combines two fields without adding any lens prescription to either field (typically a tilted dichroic plate or compound conjugate lenses). The second version includes a lensing functionality in addition to the combining functionality, which is usually an off-axis aspheric lensing prescription for the field coming from the display. The field coming from the scenery is typically not changed with any lensing functionality. The lensing functionality is often used to form the virtual image of the display into the far field or at a specific distance from the combiner.

Holographic combiners are typically used in military applications, due to their significant costs, but do provide a high quality HUD. Holographic combiners can be fabricated by exposing a dichromated gelatin, silver halides, or photopolymers to a pair of intersecting laser beams (reference and object beams). The interference pattern between these beams is recorded into the holographic media thereby forming the holographic combiner after curing. The hologram can be fabricated as a complex mirror with optical power only for the reflected wave (the wave coming from the display), leaving the transmitted wave unperturbed. A hologram can also be fabricated to operate similarly in transmission mode. The complex mirror property reflects a given wavelength incident at a given angle in a desired direction, while the optical power property provides a lensing function, such as a concave reflector. This is the Bragg condition of a traditional volume hologram. However, holographic combiners have a number of drawbacks. They are expensive to fabricated, difficult to mass produce, and have limited life spans (e.g., begin to degrade due to temperature, humidity, pressure and other harsh environmental conditions).

Angled transparent substrate combiners have been used in automobiles to present the driver with HUD information on the windshield. These optical combiners are made of a clear see-through substrate upon which an external image source displays the CGI. However, since the clear see-through substrate is typically a flat substrate without optical power so as not to distort the external FOV, the clear substrate must be angled (e.g., near 45 degrees) and bulky external magnification lenses are used to expand the CGI over the display region. The bulky external lenses and angled nature of the clear see-through substrate combiners do not lend themselves well to compact arrangements, such as head mounted displays (“HMDs”).

Compound conjugate lens combiners are often used in scopes to display an image (e.g., gun sights) over an external view. These optical combiners include two lenses. The first lens is positioned nearer to the eye, relative to the second lens, and includes a partial reflective coating to project a virtual image of an object (laser reticle for instance) into the user's eye. The first lens also provides optical power to enlarge the image and virtually displace the image back from the eye to bring it into focus in the case of a near-to-eye display. The second lens is positioned in-line with the first lens opposite the user's eye and provides complementary optical power to the first lens to pre-distort the external view to offset the optical effects of the first lens on the external view. Compound lens combiners lend themselves well to the barrel configuration of a scope, but are otherwise bulky and rather heavy—thus not well suited for use in HMD configurations.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1 is a cross sectional view of a sandwiched diffractive optical combiner, in accordance with an embodiment of the disclosure.

FIG. 2 is a plan view of a sandwiched diffractive optical combiner, in accordance with an embodiment of the disclosure.

FIG. 3 is a flow chart illustrating a process for fabricating a sandwiched diffractive optical combiner using lithography, in accordance with an embodiment of the disclosure.

FIGS. 4A-4F illustrate fabrication steps for fabricating a sandwiched diffractive optical combiner using lithography, in accordance with an embodiment of the disclosure.

FIG. 5 is a top view of a binocular head mounted display using two sandwiched diffractive optical combiners, in accordance with an embodiment of the disclosure.

### DETAILED DESCRIPTION

Embodiments of an apparatus, system, and methods of fabrication of a sandwiched diffractive optical combiner are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

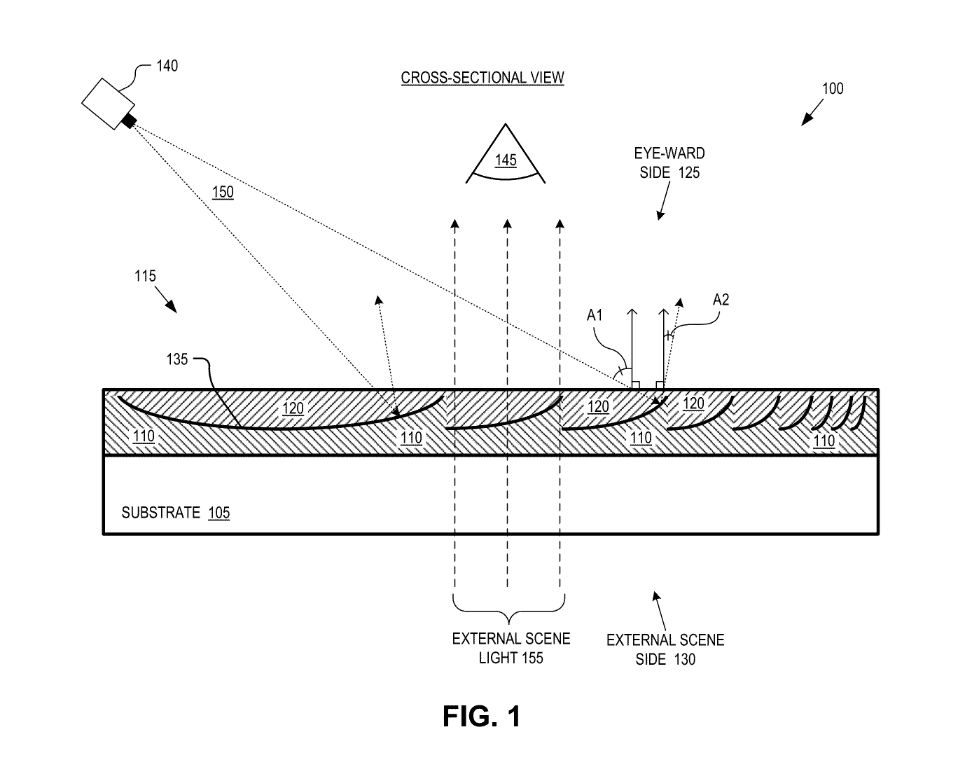

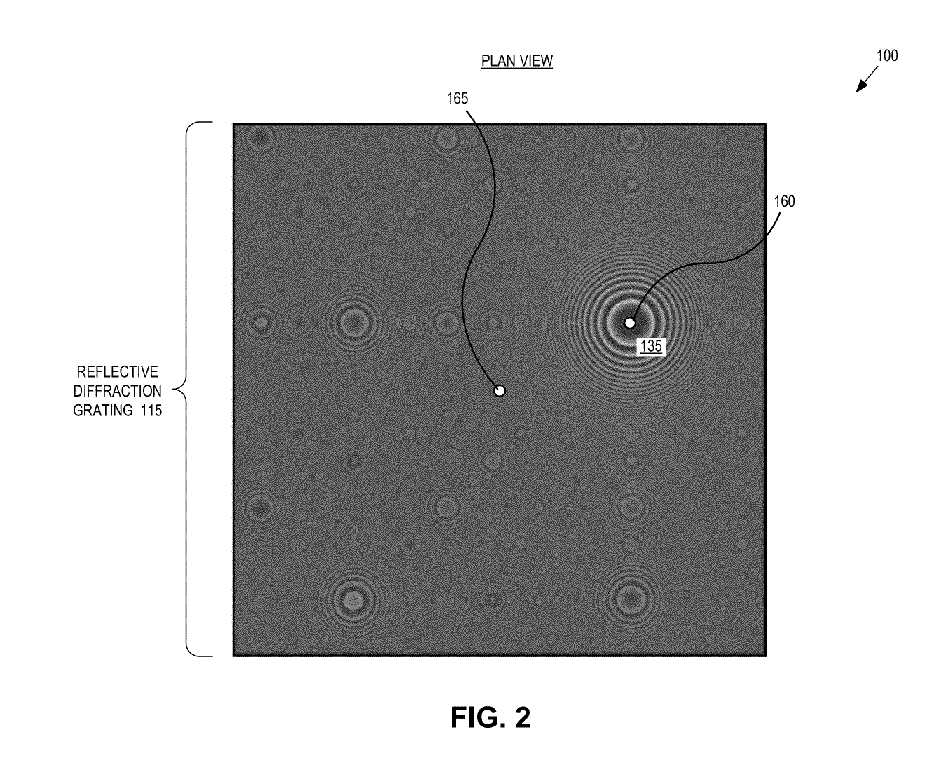

FIGS. 1 and 2 illustrate a sandwiched diffractive optical combiner 100, in accordance with an embodiment of the disclosure. FIG. 1 is a cross-sectional view of optical combiner 100 while FIG. 2 is a plan view of the same. The illustrated embodiment of optical combiner 100 includes a substrate 105, a base sandwich layer 110, a reflective diffraction grating 115, a planarization sandwich layer 120, an eye-ward side 125, and an external scene side 130. The illustrated embodiment reflective diffraction grating 115 is formed of a two-dimensional (“2D”) array of three-dimensional (“3D”) diffraction element shapes formed into base sandwich layer 110 with partially reflective elements 135 coated onto the 3D diffraction elements shapes and conforming thereto.

Optical combiner 100 is referred to as a sandwiched optical combiner since it sandwiches reflective diffraction grating 115 between two material layers (i.e., base sandwich layer 110 and planarization sandwich layer 120) having substantially equal, if not identical, indexes of refraction. By doing this, optical combiner 100 simultaneously operates in both reflection and transmission modes with each mode having different characteristics. In reflection, an image source 140 is positioned on the same side of optical combiner 100 as the user's eye 145 (i.e., eye-ward side 125). Since reflective diffraction grating 115 is composed of partially reflective elements 135, a portion of image light 150 output from image source 140 is reflected back towards the user's eye 145. In transmission, the diffractive effects of reflective diffraction grating 115 are annihilated by using the same or similar index of refraction material above and below partially reflective elements 135. Since partially reflective elements 135 are also partially transmissive and sandwiched in substantially uniform index material(s), the portion of external scene light 155 that passes through reflective diffraction grating 115 is not diffracted, but rather passes to eye 145 substantially without optical distortion. By simultaneously operating optical combiner 100 in both reflective and transmissive modes, it can be used to overlay image light 150 onto external scene light 155 to provide a type of augmented reality to the user.

In some embodiments, the shape, size, orientation, and placement of the individual 3D diffraction element shapes formed into base sandwich layer 110 maybe designed to provide optical power for magnifying image light 150. This magnifying configuration may be particularly useful in near-to-eye configurations, such as head mounted displays (“HMDs”) and some types of heads up displays (“HUDs”), such as scopes. The generic design of diffraction gratings that provide optical power is well known. For example, design of diffractive optics is discussed in “Applied Digital Optics: From Micro-optics to Nanophotonics” by Bernard Kress and Patrick Meyrueis, published by John Wiley and Sons in 2009. In particular, this book discusses how to design and subsequently carve out diffraction structures (microscopic grooves) and select their depth to maximize the amount of light diffracted in a specific diffraction order, while reducing the light diffracted in the zero and higher diffraction orders.

In one embodiment, reflective diffraction grating 115 is an off-axis lens, which is capable of receiving input light at incident angle A1 and reflects the image light along a reflection path having an emission angle A2 that is different from A1. Note, A1 and A2 are measured from the normal of the emission surface of optical combiner 100 out which the reflected image light 150 is emitted. In FIG. 1, the emission surface coincides with eye-ward side 125 of planarization sandwich layer 120. In one embodiment, incident angle A1 is greater or more oblique from normal than emission angle A2. This enables image source 140 to be positioned laterally to optical combiner 100 so as not to block external scene light 155. In HMD configurations, off-axis lensing permits image source 140 to be positioned peripherally in the temple region of the user thereby not obstructing the user's forward vision. The off-axis lensing redirects the emission angle A2 to be less oblique from normal than the incident angle A1, thereby directing the reflected image light into the user's eye at a closer to normal angle, versus overshooting the eye and illuminating the nose. Off-axis lensing using diffractive optics also provides a specific angular bandwidth to reflective diffraction grating 115. This helps reduce distractions due to backside reflections and improve contrast of the reflected image light 150 over external scene light 155.

In FIG. 2, the off-axis lensing is achieved by chirping the diffraction grating pattern and offsetting the center 160 of the pattern relative to the user's center of vision 165. In the illustrated embodiment, the pattern center 160 is denoted as the center of the largest partially reflective element 135. As the pattern extends out from center 160, partially reflective elements 135 become gradually smaller. In FIGS. 1 and 2, the 3D diffraction element shapes have parabolic cross-sectional shapes (see FIG. 1) and rotationally symmetric (circular or spherical lens) or non rotationally symmetric (aspheric lens) perimeter shapes (see FIG. 2). However, other cross-sectional shapes and perimeter shapes (e.g., elliptical, etc.) may be used to create reflective diffraction grating 115. The illustrated embodiment of FIG. 2 is a 16 phase level off-axis diffractive lens; however, other number of phase levels may be used, the most effective lens having an infinite number of phase levels (quasi analog surface relief diffractive lens).

Reflective diffraction grating 115 is formed by overlaying each 3D diffraction element shape with a partially reflective element 135. Partially reflective elements 135 each conformally coat a corresponding 3D diffraction element shape thereby creating a reflective structure that assumes the shape and orientation of the underlying 3D diffraction element shape.

Partially reflective elements 135 may be made of a variety of different materials. In one embodiment, partially reflective elements 135 are fabricated of a layer of conventional non-polarizing beam splitter material (e.g., thin silver layer, CrO2, etc.). The degree of reflectivity may be selected based upon the particular application (e.g., primarily indoor use, outdoor use, combination use, etc.). In one embodiment, partially reflective elements 135 comprise a 10% reflective 100 nm layer of CrO2.

In one embodiment, partially reflective elements 135 are fabricated of a multi-layer dichroic thin film structure. Dichroic films can be created to have a selectable reflectivity at a selectable wavelength. Additionally, the dichroic film can be designed to improve the angle selectivity of the reflective diffraction grating 115. A dichroic film can be designed with high reflectivity to a specific wavelength or wavelength band that overlaps with image light 150 and to the angles of incidence of image light 150, while being substantially more transparent to other visible spectrum wavelengths and to the normal incidence of external scene light 155. In this manner, the efficiency of optical combiner 100 can be improved while also increasing the brightness of the transmitted external scene light 155.

In one embodiment, partially reflective elements 135 are fabricated of polarizing beam splitter material that substantially reflects one linear polarization of incident light while substantially passing the orthogonal linear polarization. In this case, image source 140 could be designed to emit polarized image light matching the reflection characteristic of partially reflective elements 135. Since ambient light typically has a random polarization, approximately 50% of external scene light 155 would pass through optical combiner 100 to eye 145.

Image source 140 may be fabricated using a variety of compact image source technologies such as the various micro-displays used today in pico-projectors, liquid crystal on silicon (“LCOS”) displays, backlit liquid crystal displays, organic light emitting diode (“OLED”) displays, quantum dot array displays, light emitting diode (“LED”) arrays, or otherwise. CRT tubes are still used in HUDs today, but are less likely to be used in smaller devices such as see through Head Mounted Displays (HMDs). Optical combiner 100 may be fabricated of a variety of clear optically transmissive materials, including plastic (e.g., acrylic, thermo-plastics, poly-methyl-metha-crylate (PMMA), ZEONEX-E48R, glass, quartz, etc.). For example, in one embodiment, substrate 105, base sandwich layer 110, and planarization sandwich layer 120 are fabricated of plastic. In another embodiment, substrate 105 is glass while base sandwich layer 110 and planarization sandwich layer 120 are fabricated of silicon dioxide. Of course, other material combinations may be used.

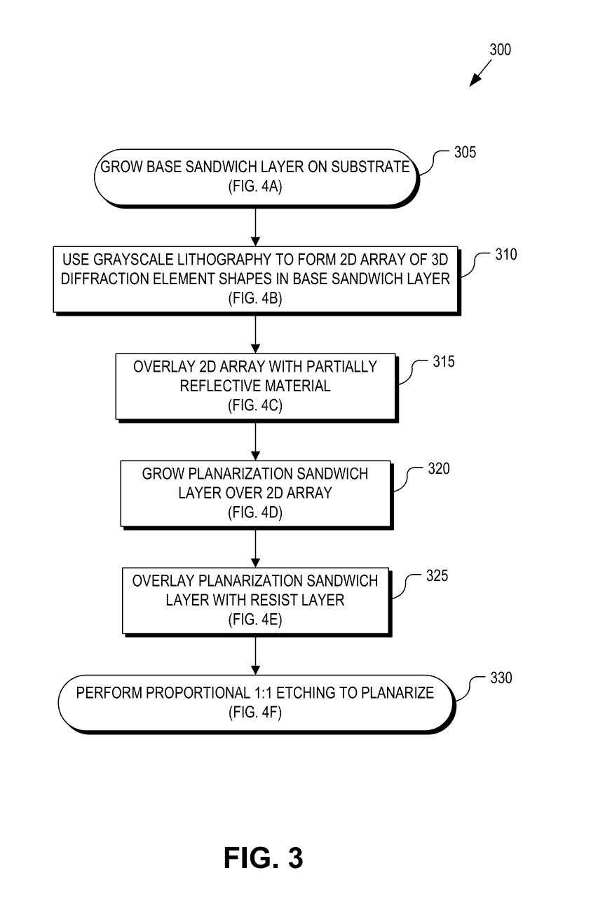

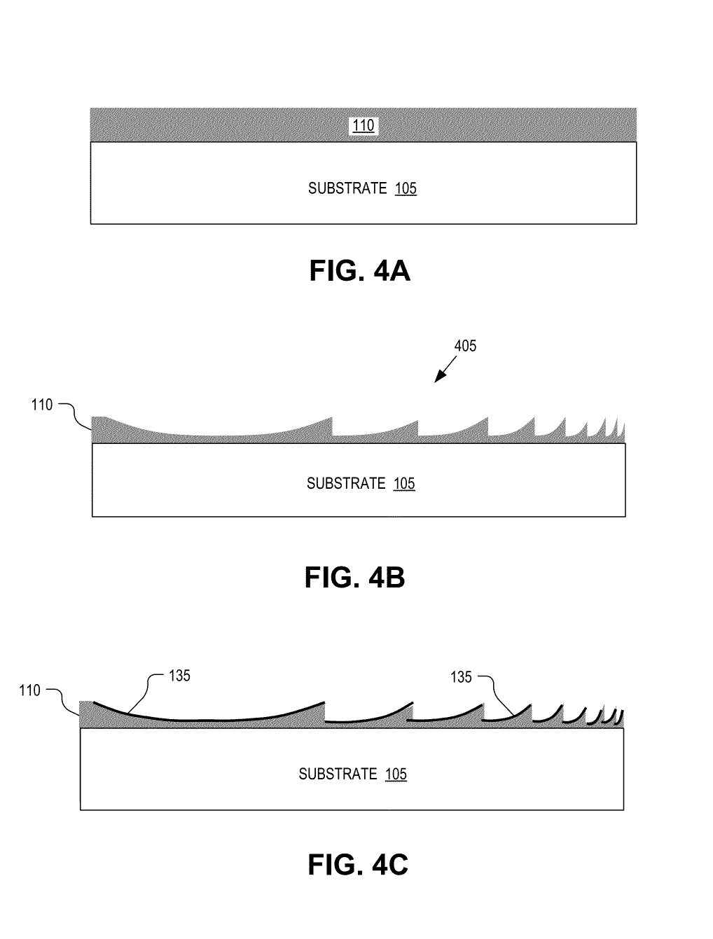

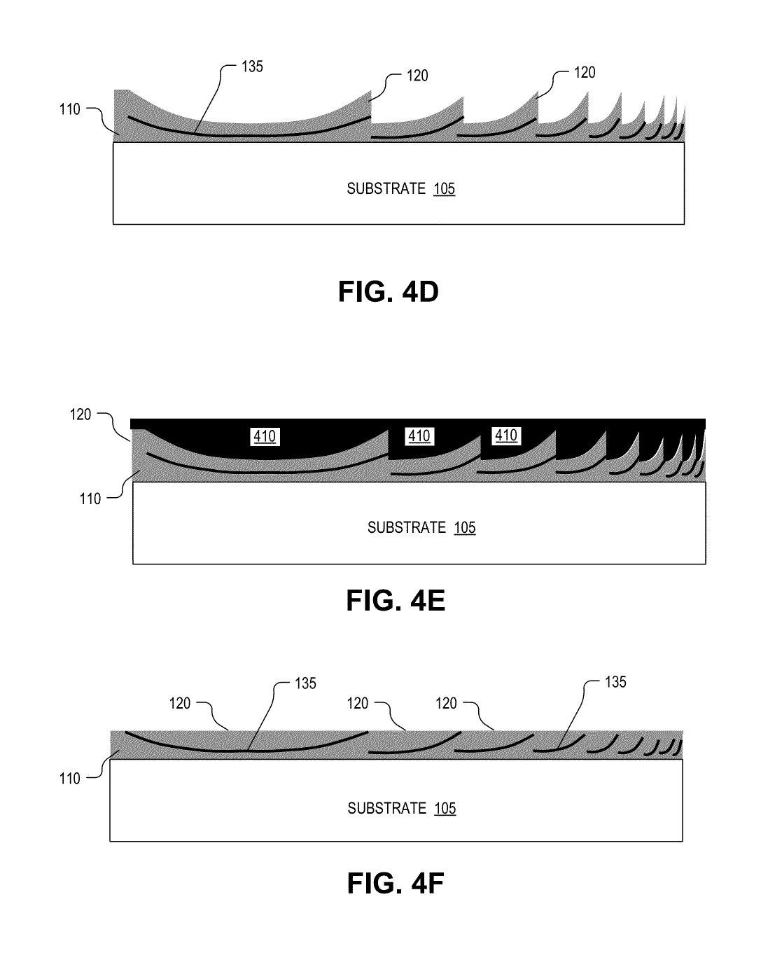

FIG. 3 is a flow chart illustrating an example process 300 for fabricating one embodiment of sandwiched diffractive optical combiner 100 using lithography, in accordance with an embodiment of the disclosure. Process 300 describes one technique for fabricating an embodiment of optical combiner 100 using silicon dioxide on a glass substrate. Process 300 is described with reference to FIGS. 4A-F. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

In a process block 305, base sandwich layer 110 is deposited onto substrate 105, which is fabricated of a clear material such as glass, quartz, plastic, or otherwise. In this embodiment, base sandwich layer 110 is a layer of silicon dioxide approximately 1 μm thick. In a process block 310, grayscale lithography and reactive ion etching is used to form the 2D array of 3D diffraction shapes 405 into base sandwich layer 110. In a process block 315, shapes 405 are overlaid via sputtering with a layer of partially reflective material. In one embodiment, the partially reflective material layer is approximately 10% reflective (other reflectivity percentages may be used). In one embodiment, the partially reflective material layer is approximately 100 nm thick of CrO2 material. In a process block 320, planarization sandwich layer 120 is deposited onto of the partially reflective material layer. In one embodiment, planarization sandwich layer 120 is deposited to be approximately 1.5 μm thick. Of course, at this stage planarization sandwich layer 120 is not yet planar. In a process block 325, a resist material 410 is coated over planarization sandwich layer 120. Finally, in a process block 330, resist material 410 is removed during planarization, which proceeds to a depth that results in a planar top to planarization sandwich layer 120. Such a process can be implemented as a proportional reactive ion etching (RIE) process (or CAIBE process—Chemically Assisted Ion Beam Etching) where the resist etching rate and the underlying SiO2 etching rate are exactly similar. In one embodiment, chemical-mechanical polishing is used to remove resist layer 410 and planarize planarization sandwich layer 120. In one embodiment, a proportional reactive ion etch with a 1:1 ratio that etches both resist material 410 and planarization sandwich layer 120 at the same rate is used. Other standard or custom planarization techniques may be used.

Mass production techniques may be used to fabricate various other embodiments of optical combiner 100. For example, a master combiner may be fabricated to be used as a mold for plastic replication via injection molding or hot/UV embossing. Base sandwich layer 110 may be fabricated of thermo-plastic material that is injection molded. Partially reflective elements 135 may be overlaid or coated onto the 2D array of 3D diffraction shapes and planarization sandwich layer 120 laminated over the partially reflective material. Diamond turning with CNC machine-tools may be used in place of lithography to shape the various curved fringes making up the optical combiner. In other embodiments, base sandwich layer 110 may be fabricated using press molding into thermo-plastic or plastic embossing using a roller drum having a negative impression of the 2D array of 3D diffraction shapes disposed thereon.

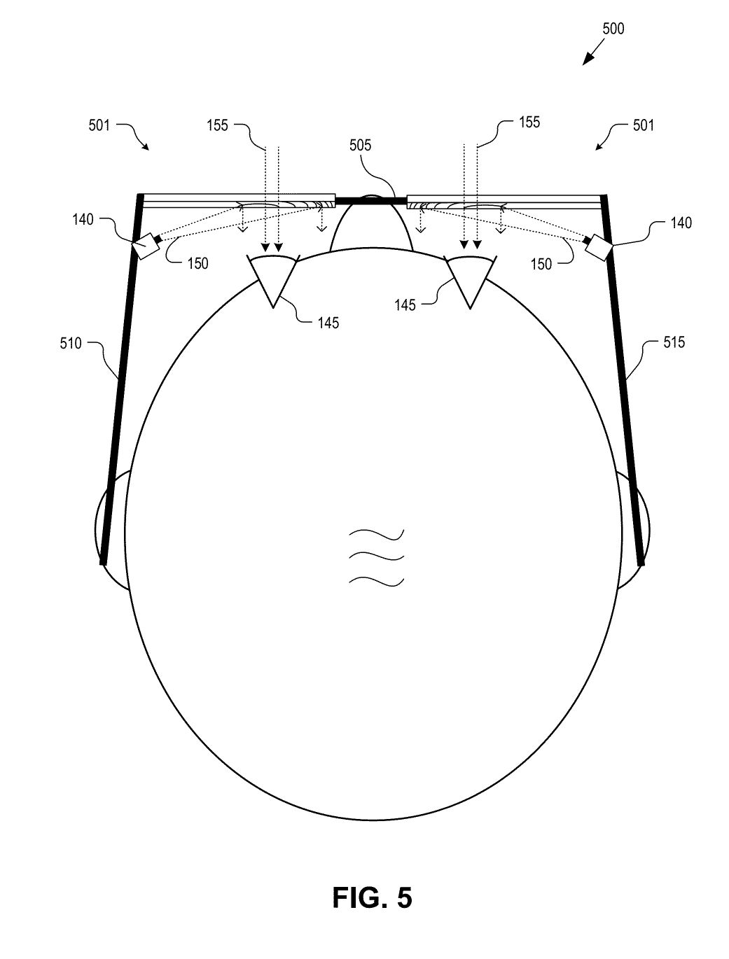

FIG. 5 is a top view of a binocular HMD 500 using a pair of sandwiched diffractive optical combiners 501, in accordance with an embodiment of the disclosure. Each optical combiner 501 may be implemented with an embodiment of optical combiner 100. The optical combiners 501 are mounted to a frame assembly, which includes a nose bridge 505, left ear arm 510, and right ear arm 515. Although FIG. 5 illustrates a binocular embodiment, HMD 500 may also be implemented as a monocular HMD.

The two optical combiners 501 are secured into an eye glass arrangement that can be worn on the head of a user. The left and right ear arms 510 and 515 rest over the user's ears while nose assembly 505 rests over the user's nose. The frame assembly is shaped and sized to position each optical combiner 501 in front of a corresponding eye 145 of the user. Of course, other frame assemblies having other shapes may be used (e.g., a visor with ear arms and a nose bridge support, a single contiguous headset member, a headband, goggles type eyewear, etc.).

The illustrated embodiment of HMD 500 is capable of displaying an augmented reality to the user. Each optical combiner 501 permits the user to see a real world image via external scene light 155. Left and right (binocular embodiment) image light 150 may be generated by image sources 140 mounted to left and right ear arms 510. Image light 150 is seen by the user as a virtual image superimposed over the real world as an augmented reality. In some embodiments, external scene light 155 may be blocked or selectively blocked to provide sun shading characteristics and increase the contrast of image light 150.

While the microscopic structures of the 2D array of 3D diffraction shapes along with the conforming partially reflective elements 135 produce the optical combiner effect, the macroscopic shape of optical combiners 501 (or 100) can include overall curvatures to include a corrective lensing prescription. For example, the external scene side of substrate 105 and/or base sandwich layer 110 may include a first curvature that imparts a corrective lensing prescription. Additionally (or alternatively), the eye-ward side surface of planarization sandwich layer 120 may include a second curvature that imparts a corrective lensing prescription. The first and second curvatures may be different, and in one embodiment, one of the two curvature may be flat while the other is curved.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An optical combiner having an eye-ward side and an external scene side, the optical combiner, comprising:
a base sandwich layer having a first index of refraction and including a first side facing the eye-ward side;
a two-dimensional (“2D”) array of three-dimensional (“3D”) diffraction element shapes disposed in the first side of the base sandwich layer;
partially reflective elements each coating one of the 3D diffraction element shapes and conforming thereto, wherein the partially reflective elements collectively form a reflective diffraction grating having magnifying optical power for image light incident on the reflective diffraction grating through the eye-ward side of the optical combiner; and
a planarization sandwich layer disposed over the partially reflective elements having a second index of refraction substantially equal to the first index of refraction of the base sandwich layer such that external scene light incident through the external scene side passes through the optical combiner substantially without diffraction while the image light incident through the eye-ward side is reflected and magnified via the reflective diffraction grating.

2. The optical combiner of claim 1, wherein the base sandwich layer includes a second side opposite the first side and facing the external scene side, the optical combiner further comprising:
an optically transmissive substrate physically mated to the second side of the base sandwich layer to provide mechanical support to the base sandwich layer and the reflective diffraction grating.

3. The optical combiner of claim 1, wherein the reflective diffraction grating comprises an off-axis diffractive lens that receives the image light incident upon the eye-ward side at a first angle and reflects the image light along a reflection path having a second angle, wherein the first angle is more oblique relative to a normal of an emission surface of the planarization sandwich layer than the second angle.

4. The optical combiner of claim 1, wherein the partially reflective elements each comprises a dichroic film, wherein a reflectivity of the reflective diffraction grating to the image light is both wavelength and angle dependent.

5. The optical combiner of claim 1, wherein the partially reflective elements each comprise a reflective polarizing film that substantially reflects a first linear polarization while substantially passing a second linear polarization orthogonal to the first linear polarization.

6. The optical combiner of claim 1, wherein the partially reflective elements each comprise a non-polarizing beam splitter film.

7. The optical combiner of claim 1, wherein the base sandwich layer and the planarization sandwich layer comprise plastic.

8. The optical combiner of claim 1, wherein the base sandwich layer and the planarization sandwich layer comprise silicon dioxide.

9. The optical combiner of claim 1, wherein the external scene side of the optical combiner has a first curvature that is different than a second curvature of the eye-ward side such that a macro-shape of the optical combiner comprises a corrective lens.

10. A head mounted display (“HMD”) for combing image light with external scene light, the HMD comprising:
an image source to generate the image light;
an optical combiner including:
a base sandwich layer including a first side facing an eye-ward side of the optical combiner;
a two-dimensional (“2D”) array of three-dimensional (“3D”) diffraction element shapes disposed in the first side of the base sandwich layer;
partially reflective elements each coating one of the 3D diffraction element shapes, wherein the partially reflective elements collectively form a reflective diffraction grating having magnifying optical power for the image light incident on the reflective diffraction grating from the eye-ward side; and
a planarization sandwich layer disposed over the partially reflective elements having an index of refraction substantially equal to that of the base sandwich layer such that the external scene light incident from an external scene side passes through the optical combiner substantially without diffraction while the image light incident from the eye-ward side is reflected and magnified via the reflective diffraction grating; and
a frame assembly to support the image source and the optical combiner for wearing on a head of a user with the optical combiner positioned in front of an eye of the user.

11. The HMD of claim 10, wherein the base sandwich layer includes a second side opposite the first side and facing the external scene side, the optical combiner further comprising:
an optically transmissive substrate physically mated to the second side of the base sandwich layer to provide mechanical support to the base sandwich layer and the reflective diffraction grating.

12. The HMD of claim 10, wherein the reflective diffraction grating comprises an off-axis diffractive lens that receives the image light incident upon the eye-ward side at a first angle and reflects the image light along a reflection path having a second angle, wherein the first angle is more oblique relative to a normal of an emission surface of the planarization sandwich layer than the second angle.

13. The HMD of claim 10, wherein the partially reflective elements each comprise a dichroic film, wherein a reflectivity of the reflective diffraction grating to the image light is both wavelength and angle dependent.

14. The HMD of claim 13, wherein the image source is mounted to the frame relative to the optical combiner such that an angle of incidence of the image light upon the reflective diffraction grating is at or near a maximal angular reflectivity of the reflective diffraction grating.

15. The HMD of claim 10, wherein the partially reflective elements each comprise a reflective polarizing film that substantially reflects a first linear polarization while substantially passing second linear polarization orthogonal to the first linear polarization.

16. The HMD of claim 10, wherein the partially reflective elements each comprise a non-polarizing beam splitter film.

17. The optical combiner of claim 10, wherein the external scene side of the optical combiner has a first curvature that is different than a second curvature of the eye-ward side such that a macro-shape of the optical combiner comprises a corrective lens.

18. A method of fabricating an optical combiner having an eye-ward side and an external scene side, the method comprising:
etching a first side of a base sandwich layer to form a two-dimensional (“2D”) array of three-dimensional (“3D”) diffraction element shapes in the first side of the base sandwich layer that faces the eye-ward side;
overlaying the 2D array of 3D diffraction element shapes with a partially reflective layer to form a reflective diffraction grating having magnifying optical power for image light incident on the reflective diffraction grating from the eye-ward side of the optical combiner;
forming a planarization sandwich layer over the partially reflective layer, wherein the planarization sandwich layer has a first index of refraction that is substantially equivalent to a second index of refraction of the base sandwich layer; and
planarizing the planarization sandwich layer.

19. The method of claim 18, further comprising:
depositing the base sandwich layer on a clear substrate layer, wherein a second side of the base sandwich layer that faces the external scene side is physically mated to the clear substrate layer.

20. The method of claim 19, wherein the clear substrate layer comprises plastic or glass and the base sandwich layer and the planarization sandwich layer comprise silicon dioxide.

21. The method of claim 18, wherein planarizing the planarization sandwich layer comprises:
coating the planarization sandwich layer with a resist layer that etches at a same rate as the planarization sandwich layer; and
performing a proportional 1:1 etch of the resist layer and the planarization sandwich layer until the resist layer is removed and the planarization sandwich layer is planarized.

22. The method of claim 18, wherein planarizing the planarization sandwich layer comprises:
chemically-mechanically polishing the planarization sandwich layer to a plane.
a planarization sandwich layer disposed over the partially reflective elements having an index of refraction substantially equal to that of the base sandwich layer such that the external scene light incident from an external scene side passes through the optical combiner substantially without diffraction while the image light incident from the eye-ward side is reflected and magnified via the reflective diffraction grating; and

23. The method of claim 18, wherein the reflective diffraction grating comprises an off-axis diffractive lens for receiving the image light incident upon the eye-ward side at a first angle and for reflecting the image light along a reflection path having a second angle, wherein the first angle is more oblique relative to a normal of an emission surface of the planarization sandwich layer than the second angle.

24. The method of claim 81, wherein the partially reflective layer comprises a dichroic film, wherein a reflectivity of the reflective diffraction grating to the image light is both wavelength and angle dependent.

25. The method of claim 18, wherein the partially reflective layer comprises a reflective polarizing film that substantially reflects a first linear polarization while substantially passing a second linear polarization orthogonal to the first linear polarization.

26. The method of claim 18, wherein the partially reflective layer comprises a non-polarizing beam splitter film.
